(19) United States
(12) Patent Application Publication
(10) Pub. No.: US 2016/0012472 A1
(43) Pub. Date: Jan. 14, 2016

(54) Adaptable data collection and analytics platform for matching and monitoring commuter drivers with driven messaging campaigns

(71) Applicant: Mac M. Nagaswami, Newark, DE (US)

(72) Inventor: Mac M. Nagaswami, Newark, DE (US)

(21) Appl. No.: 14/847,159

(22) Filed: Sep. 8, 2015

Related U.S. Application Data
(60) Provisional application No. 62/021,984, filed on Jul. 8, 2014.
(60) Provisional application No. 62/098,615, filed on Dec. 31, 2014.

(51) Int. Cl. G06Q 30/02; H04W 4/02; H04W 4/00

(52) U.S. Cl. CPC G06Q 30/0244; G06Q 30/0265; G06Q 30/0201; H04W 4/008; H04W 4/021; G06Q 30/0205; G06Q 30/0267

(57) ABSTRACT

An apparatus, platform, system, and method for adapting a data collection and analytics platform for matching and monitoring commuter drivers with driven messaging campaigns and converting the geographic movement of the drivers to an estimated number of human impressions. The apparatus, platform, system, and method may include receiving a plurality of indications of the geographic movement; accessing traffic data comprising at least an average number of passing vehicles on a route correspondent to the geographic movement, an average number of persons per one of the passing vehicles, and an average number of pedestrians on the route; and based on the traffic data and the geographic movement, summing the number of human impressions along the route.

### BACKGROUND

1. Field of the Disclosure

The field of the invention is adaptable tracking technology to enable commuter driver data collection and analytics. More particularly the mobile tracking unit technology combines with networked devices and databases to create a secure data platform for matching and monitoring commuter drivers with driven messaging campaigns, including the placement and tracking of physically mobile advertisements.

2. Background of the Disclosure

Global positioning systems (GPS) and similar location tracking systems have enabled real-time navigation services in outdoor environments. Navigation systems are effective if the position data is reliable, accurate and is obtained economically. Prior attempts to create a universal, open-ended location tracking system using, for example, any common cellular telephone, demonstrate the benefit and desire of utilizing tracking information in a system that is not device-specific, i.e., a system that works with any common mobile communications device, regardless of the manufacturer.

U.S. Pat. No. 5,388,147 describes such a system, wherein a cellular telephone converts geo-coordinates to location information and transmits the location information to a cellular telecommunications system. The problem with this system is that the location information obtained from the geo-coordinates is often too coarse to have much value in locating a cell phone user. Another problem with this system is that the cellular telephones are not capable of transmitting the digital data containing the location information over the same voice channel established by the cell phone operator to communicate with a tracking system operator. Portable locator devices, such as stand-alone GPS units, typically utilize a communications network completely separate from the cellular network.

An attempt to address these shortcomings are described in PCT Patent Publication No. WO2001020582 by Lutter et al., wherein is described a dosed loop tracking system that accurately tracks targets by polling a mobile unit for positional data on a real-time and historical basis and the polled data is filtered and corrected before generating track candidates. The tracking system chooses the best candidate for displaying on a map. When the tracking system needs additional information to make the best candidate choice, the mobile unit is polled for the data necessary to make the correct choice, making the tracking system closed loop. The system of Lutter et al. transmits digital positional data over the same voice channel that was established for voice communications with a tracking system call taker, which prevents the mobile unit from having to establish a second separate wireless data communication connection with the tracking system. The drawback of this system, however is that the mobile unit must be repeatedly polled for position data that must be further filtered and corrected. It is necessary to determine a system that allows for collection of location data from any type of wirelessly enabled mobile unit, but does not require that the mobile unit be remotely polled or that the polling data be later corrected.

Beyond communicating navigation information through a wireless mobile unit, location tracking has long been recognized as a tool for monitoring and analysis of assets deployed in the field. Generally such monitoring and analysis has been through closed systems, i.e., systems in which the entity that designs, makes, owns or controls the asset also designs, makes, owns or controls the mobile tracking unit associated with the asset. Such systems are not designed to collect, communicate, analyze and display location data from any generic form of wirelessly enabled mobile tracking unit, such as the competing smartphones in today's market. Nor are these prior art tracking systems designed to collect data from independently networked mobile tracking units.

A further drawback of modern day location tracking systems is the inability to collect from the mobile tracking unit additional information from and about the environment being traversed, other than geo-location information. Techniques for obtaining other environmental indicators, such as the number/density of other nearby wireless devices or the number of detectable wireless communication networks in the vicinity, may enable enhanced location data analytics, for example, to provide estimates regarding population density and/or economic resources within a specific area traversed. A client (e.g. an application, a server or a user) who needs the location of one or more mobile devices as well as the environmental indicators collected by those devices, may require more flexible location services from a network or a location server than are currently defined and supported for mobile devices that are typically more limited.

Aside from asset tracking, location services have become particularly relevant to individuals engaged in motorized transport, a ubiquitous component of American life. According to the 2013 Edition of the Arbitron Out-of-Home Advertising Study, nearly 9 in 10 (89%) U.S. residents age 18 or older used motorized transportation including cars, trucks, buses, taxis and commuter rails in the past month. The Study further indicates that among those that have driven or ridden in any vehicle in the past month, 84% have noticed billboard, transit or street level advertising in the past month. According to a 3M Mobile Media Advertising Case Study conducted by Ad Agency RYP & Becker Group in 2011 on mobile advertising on vehicles, 97% of survey respondents recalled the vehicle ad, 98% reported that the vehicle ad created a positive image of the advertiser, and 96% thought the vehicle ad had a greater impact than a billboard. As reflected by these survey results, commercial transportation fleets have long recognized the value of placing trademarks, business information, and promotional graphics on fleet vehicles to create a mobile advertisement for the associated commercial enterprise.

Relatively unutilized or under-utilized for the purpose of displaying mobile advertisements on vehicles are non-commercial drivers, for example the display of an advertisement on the non-commercial, privately owned or leased vehicle of, for example, a residential commuter driver. One of the reasons for this under-utilization is the inability to determine which commuter drivers are appropriately suited for a particular mobile advertising campaign, whether an engaged commuter driver likely reached a target number of impressions during the mobile advertising campaign, and whether the commuter driver drove to forbidden locations with the mobile advertisement. The present system solves these shortcomings.

From the standpoint of an advertiser, a commuter driven mobile advertisement differentiates that advertisement in the marketplace. This is in contrast with more common and familiar outdoor advertising media, such as a billboard or similar fixed advertisement. As these advertisements are repeatedly encountered at the same location by the viewing public, the likelihood that theses advertisements can seize a prospective buyer's attention diminishes.

As noted above, the usefulness of such physically mobile advertising campaigns has historically been limited to commercial fleet advertisements associated with the enterprise of the commercial driver. Moreover, commercial fleet advertisements are generally driven to locations for the purpose of engaging in a specific commercial activity, such as product or service delivery. They are not specifically driven into a geographic location in order to target a particular neighborhood or demographic, or type of viewer, or the like. Even more so, there has historically been no mechanism whereby the placement and success of a commuter-route targeted mobile advertising campaign, with regard to the targeted purposes, can be tracked.

Therefore, the need exists for an adaptable tracking technology to enable commuter driver data collection and analytics, by combining mobile tracking devices with networked devices and databases to create a secure data platform for matching and monitoring commuter drivers with driven messaging campaigns, including the placement and tracking of physically mobile advertisements.

### SUMMARY OF THE INVENTION

The present invention is and includes an end-to-end apparatus, system and method for adaptable tracking technology to enable commuter driver data collection and analytics, by combining mobile tracking devices with networked devices and databases to create a secure data platform for matching and monitoring commuter drivers with driven messaging campaigns, including the placement, tracking and analysis of physically mobile advertisements. Such an apparatus, system and method will allow for better placement, tracking and analysis of physically mobile advertisements.

Disclosed herein is a novel cloud-based software analytics platform with limited secure portal access for customers and agents to access selective GPS-related information to which those customers and agents are authorized. The platform further includes a rules-based decision engine enabled to automatically find and match driver applicants to a customer's advertising campaign, with the platform further enabled to provide real-time data access, including the estimated number of impressions based on traffic and/or population densities, mileage, routes and consumer feedback related to the campaign.

Further disclosed herein is the concept of gathering data regarding the detection of third-party wireless signals, networks, and hotspots by a mobile device, for example a driver's smartphone, traveling with and near a mobile advertisement to aid in the assessment of the audience in which the mobile advertisement is traversing. Third-party wireless signals, networks, and hotspots, as used herein, refers to wireless signals, networks and hotspots other than those established by, through or on behalf of the mobile advertiser and its agents. The gathering of information regarding the location, time, strength, type, and duration of third-party wireless signals detected during the mobile campaign, may aid in the assumptions and inferences drawn regarding the number of impression made by the advertisement. The information may also aid in making certain assumptions regarding the demographics of the audience including, for example, population density, age and affluence of the audience to whom the advertisement is brought within proximity at various geographically-tracked locations.

Further disclosed herein is the concept that information along and about the route of a mobile advertisement may be automatically gathered, communicated in real-time, and decisioned through a rules-based decision engine to automatically determine whether and when to change the content of the dynamic mobile advertisement and further determine which advertisement, among multiple options, to dynamically display. Automated decisioning regarding whether and when to change the content of the dynamic mobile advertisement, and which content to display, may be made based on the current geographic location of the mobile advertisement along the route as determined by a geo-positioning device, such as a GPS-enabled smartphone, traveling with and near the mobile advertisement. Moreover, automated decisioning may further be enhanced by the establishment of additional rules dictating changes to the mobile advertisement content based on other variables detected along the route, including third-party wireless signals, and/or communications to the decision-engine related to real-time viewer feedback.

Further disclosed herein is the concept of a mobile device app, i.e., a mobile advertising campaign app or campaign app, designed to collect and wirelessly communicate to the software analytics platform servers GPS tracking data from a driver-applicant's GPS-enabled mobile device. The collected and communicated GPS data may be automatically processed by a decision engine that determines whether the repeated routes driven by the applicant meet criteria to select the applicant for a particular mobile advertisement campaign.

Further disclosed herein is the concept of a coupled transmission system including a limited-range radio broadcast signal, or other wireless signal, through which the public may receive the broadcast signal, coupled with a dynamic mobile advertisement traveling with and near a limited or near-range wireless signal transmitter. The limited-range signal may include an AM or FM broadcast signal transmitting audio content discernable through a common portable radio, for example a traditional car radio, that may include information related to the visible nearby dynamic mobile advertisement. The limited-range signals may also include wifi or Bluetooth signals transmitting data discernable through portable electronic devices such as wifi and Bluetooth enable smartphones. This data may include, for example, a splash page directing the public to a particular website on the internet.

Further disclosed herein is the concept of a mobile feedback collections devices, including camera and microphone enabled mobile devices, such as smartphones, which are capable of discerning, capturing, and relaying non-oral feedback communications commonly made by drivers on the road. Common methods of non-oral driver communications including flashing automobile headlight high-beams or turning an automobile's headlights off and on, as well as sounding an automobile's horn (i.e., “honking” or “beeping”). These non-oral communications may be solicited by a message displayed with a mobile advertisement and may be captured by the collections device. For example, the device may be configured to recognize and log, and possibly communicate in real-time, the time and location when two short blasts of an automobile horn are detected in the vicinity of the mobile advertisement. Similarly, an image or light sensing device may be configured to recognize and log, and possibly communicate in real-time, the time and location when flashes of light are detected in the vicinity of the mobile advertisement.

In general, the system platform includes an automated matching process of prospective commuter drivers with targeted mobile advertising campaigns using a rules-based decision engine to find correlation matches. From the prospective driver end, a prospect is directed to securely connect over the Internet to a form-field dominated graphic user interface through which the prospect may provide basic driving information or otherwise create a driver profile that will be automatically recorded into one or more robust and adaptable databases, such as SQL databases, connected to one or more servers over a secured network. Similarly, from the advertiser end, the desired components of a mobile advertisement campaign are entered into a form-field dominated graphic user interface through which an advertisement profile is created for an advertisement campaign. The advertisement profile will also be automatically recorded into one or more robust and adaptable databases connected to one or more servers over a secured network.

The advertising campaign profile will include target criteria for a desired driver, such as preferred driver demography or car type, preferred routes, preferred viewer types, etc. A rules-based decision engine connected to the database will match target criteria established by an advertiser with a matching driver prospect based on a correlation of the prospect profile with the advertisement profile. The system may further utilize governmental or private transportation tracking data to estimate a likely number of impressions a prospect may provide in a given period based on information, such as the time and location of the prospects daily commute. The system may further endeavor to automatically match a driver prospect with a mobile advertisement campaign based on the automatically calculated estimate of impressions a prospect is likely to create through the placement of the mobile advertisement on the prospect's automobile.

Once a match is decisioned through the system, based the correlation of a driver prospect's profile with an advertising campaign profile, each party to the transaction is notified. Notification may occur automatically through a secure electronic communication, such as an email, text, in-app communication, or the like. The electronic communication may allow the parties to the transaction to manifest their asset to the terms of an engagement to create and electronically document a legally binding agreement. Once an agreement for a transaction is reached, the driver will be provided with, or have installed, a vehicle advertisement, such as a magnet, a sticker decal, a vinyl wrap, or the like, and the driver may be provided with a tracking unit, such as a GPS tracker or the like, or the driver may be instructed to download a campaign app that allows for location and campaign data to be collected and communicated wirelessly through the driver's own device, e.g., a smartphone, to a secure campaign management platform.

Drivers may also utilize mobile digital signage. Mobile digital signage may be designed to allow for the content on the mobile digital display to be modified remotely by the entity transacting with the driver or through direct interactions with the driver and/or a mobile device traveling with the driver, including through the driver's smartphone. A mobile digital sign may have cellular communication capabilities through a standard cellular network, which would allow an entity through which the driver contracted to remotely modify the content of the mobile display at various periods or in real-time based on feedback provided through the mobile advertising campaign, such as positive feedback received through social media or otherwise, in response to one or more mobile advertisements. A mobile digital sign may also be adapted to allow content modification through a Bluetooth interface with a smartphone or a physical port through which a mobile device may be connected to transmit new content information, or further still, through a manual input device, such as a keypad connected or connectable to the digital sign.

In one embodiment, a driver may be requested to utilize the driver's own GPS/location services enabled through the driver's own personal communication device, such as a smartphone. Using a campaign app downloaded on a prospective driver's smartphone also solves the problem regarding how to verify the normal commuter route and driving patterns of the prospective driver described in the application for the engagement during the completion of the prospective driver profile questionnaire. The campaign app enables verification of the prospective driver's normal commute and driving patterns by collecting GPS data through the prospect's personal mobile device, such as a smartphone.

The driver's smartphone may collect and communicate GPS data through a campaign app designed for use with advertising campaigns. The campaign app may also be specially design to avoid excessive consumption of power and/or data transmission. Many mobile devices, such as smartphones, see significant increases in power consumption when utilizing the GPS tracking feature of the device. Moreover, ongoing retrieval of current GPS information may consume a significant portion of allowed data transmissions under a given plan of a wireless carrier or otherwise cause the owner of the mobile device to incur increased charges and fees. To avoid the problem of excess consumption of power and data transmission rights, the campaign app may be designed to limit the intervals at which location data is requested by the campaign app from the GPS component of the mobile device. The intervals may be adjusted based on variables such as the time of day, the day of the week, the length and complexity of the driver's normal route, prior patterns of consistent driving, other environmental indicators detectable along a driver's route, and the like.

The campaign app may further solve the problems of prospect route verification and/or excess resource consumption by detecting and recording other environmental indicators which may be correlated with locating the driver at a particular position at a particular time. For example, there may be certain wifi networks that the mobile device will be expected to detect during a traverse through a specific neighborhood. Certain restaurants and coffee shops along a route, for example, may have known public wifi access, i.e., hot spots. The detection of wifi signals from these locations may be catalogued by the app, along with the date and time of detection, to ascertain whether and when the driver traversed past these locations.

In yet a further embodiment, other means of driver identification (e.g., EZ Pass identifier, license plate, or the like) may be used to detect and track the movements of a prospective or engaged driver.

Once a means of tracking is established through the provision of a (or use of a driver's existing) mobile device, the driver's performance may be tracked and compared over the networked platform to the intended/agreed advertising campaign. The tracking may also allow for detection when a driver traverses into a region that is prohibited under the agreement. The campaign app may also be designed to notify the driver by way of an alert to the device when it has been detected that the driver has traversed into a prohibited region.

Further prohibitions may include restricting unsafe driver use of the device while driving. For example, upon download and installation of the campaign app, the driver may be required to grant the campaign app dominion over other apps and functionality on the driver's device. This dominion may allow the campaign app to disable certain apps and functions, such as texting or web browsing, when movement of the device is detected. The campaign app may further be designed to allow an acknowledgement by the driver that the driver is not presently driving in order to regain use of the disabled apps or functions.

The driver may be paid through a variety of means as requested by the driver through the establishment or updating of the driver profile. Driver compensation may be automatically calculated through the system based on measured performance metrics. For example, the system may calculate a payment to the driver based on the estimated number of likely impressions the driver enabled by driving the mobile advertisement along particular routes at particular times over a particular period. Impressions is herein defined to include all prospective, actual, or estimated viewers of an advertisement in a given time frame.

The system may further automate compensation calculation for a driver by monitoring compliance with certain pre-established criteria through the advertising campaign profile. For example, the criteria may be driving a certain number of miles in a certain geographic region at a certain time of day for a certain number of days. The criteria may further include successfully avoiding certain prohibited locations and/or certain prohibited uses of the device during the driving of the mobile advertisement. Performance with respect to the ad campaign profile, such as on a per driver or overall campaign basis, may be provided to the advertiser.

Accordingly, the present invention provides an apparatus, system and method for adaptable tracking technology to enable commuter driver data collection and analytics, by combining mobile tracking devices with networked devices and databases to create a secure data platform for matching, monitoring and analyzing the routes of commuter drivers with driven messaging campaigns, and more preferably of mobile advertisements placed on non-commercial vehicles.

### BRIEF DESCRIPTION OF THE FIGURES

Understanding of the present invention will be facilitated by consideration of the following detailed description of the preferred embodiments of the present invention taken in conjunction with the accompanying drawings, in which like numerals refer to like parts:

FIG. 1 illustrates a computer system for use in accordance with one embodiment of the present adaptable data collection and analytics platform;

FIG. 2 illustrates a networked computing environment for use in accordance with one embodiment of the present adaptable data collection and analytics platform;

FIG. 3 illustrates a mobile advertisement tracking and impressions analytics system in accordance with one embodiment of the present adaptable data collection and analytics platform;

FIG. 4 illustrates a general dashboard graphical user interface in accordance with one embodiment of the present adaptable data collection and analytics platform;

FIG. 5 illustrates a “profiles” view of a dashboard graphical user interface in accordance with one embodiment of the present adaptable data collection and analytics platform;

FIG. 6 illustrates an “impressions” view of a dashboard graphical user interface in accordance with one embodiment of the present adaptable data collection and analytics platform;

FIG. 7 illustrates a “miles” view of a dashboard graphical user interface in accordance with one embodiment of the present adaptable data collection and analytics platform;

FIG. 8 illustrates a “paths” view of a dashboard graphical user interface in accordance with one embodiment of the present adaptable data collection and analytics platform;

### DETAILED DESCRIPTION OF THE EMBODIMENTS

It is to be understood that the figures and descriptions of the present invention have been simplified to illustrate elements that are relevant for a clear understanding of the present invention, while eliminating, for the purpose of clarity, many other elements found in similar apparatuses, systems, and methods. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to the disclosed elements and methods known to those skilled in the art.

The present invention is and includes an end-to-end apparatus, system and method for the placement of and tracking of physically mobile advertisements. The driver may provide basic driving information or otherwise create a profile. The profile may include limitations on the driver's willingness to advertise certain, or certain types of, products or services.

An advertiser may enter an ad campaign profile into the present invention, into which key targeting information is entered, such as preferred driver demography or car type, preferred routes, preferred viewer types, etc., and, preferably, a number of desired impressions of one or more of the targeted prospective viewers. Desirable drivers may be matched to the ad campaign profile via software.

A match may be found between a driver's profile and an ad campaign profile. Each party in the transaction may then be notified of the match. If the parties agree to enter a transaction, the driver may be provided with, or have installed, a vehicle advertisement, such as a magnet, a sticker decal, or the like, and the driver may be provided with a tracking unit, such as a GPS tracker or the like.

Driver performance may be tracked using the tracking unit, and is electronically compared to the ad campaign information using performance software that indicates a number of impressions. The driver may be paid, such as via any means indicated in the driver profile, including but not limited to a bank account, Paypal account, Google Wallet account, credit card, or the like, according to the number of impressions, and/or by the number of impressions of the targeted type, and in compliance with the ad campaign profile.

Performance with respect to the ad campaign profile, such as on a per driver or overall campaign basis, may be reported to the advertiser. These reports may be generated automatically, such as by comparative software.

Accordingly, the present invention provides an apparatus, system and method for placement and tracking of physically mobile advertisements, and more preferably of mobile advertisements placed on vehicles. The present invention thereby connects advertised brands with vehicle drivers to provide a premium, targeted advertising medium, with well-matched drivers who meet the advertiser's targeting criteria.

Targeting criteria may include desired driver characteristics and/or route. Targeting criteria may also include pedestrian impressions, shopping centers, neighborhoods, schools, and other places difficult to obtain impressions using typical outdoor advertising means, such as billboards.

Thus, computer-implemented platforms, apparatuses, systems, and methods are disclosed for receiving driver and advertiser/ad campaign profiles, for matching drivers to ad campaigns, and for tracking ad campaign and/or driver performance. This providing of the presently inventive platforms, apparatuses, systems, and methods may occur intra-application (“app”), via combinations of intra-app and extra-app features, or exclusively extra-app, such as via a Web-based interface, by way of example. As used herein, an app may preferably indicate a dedicated functionality application, such as may be provided on a mobile device, such as a smartphone, PDA, or a tablet computer, although, in certain embodiments an app may be partially or entirely included on a stationary device, such as a desktop or a laptop computer.

The described computer-implemented embodiments are intended to be exemplary and not limiting. As such, it is contemplated that the herein described apparatuses, systems and methods may be adapted to provide many types of driver and advertiser tracking, ad campaign placement, and ad campaign tracking, and can be extended to provide numerous enhancements and/or additions to the exemplary embodiments described herein.

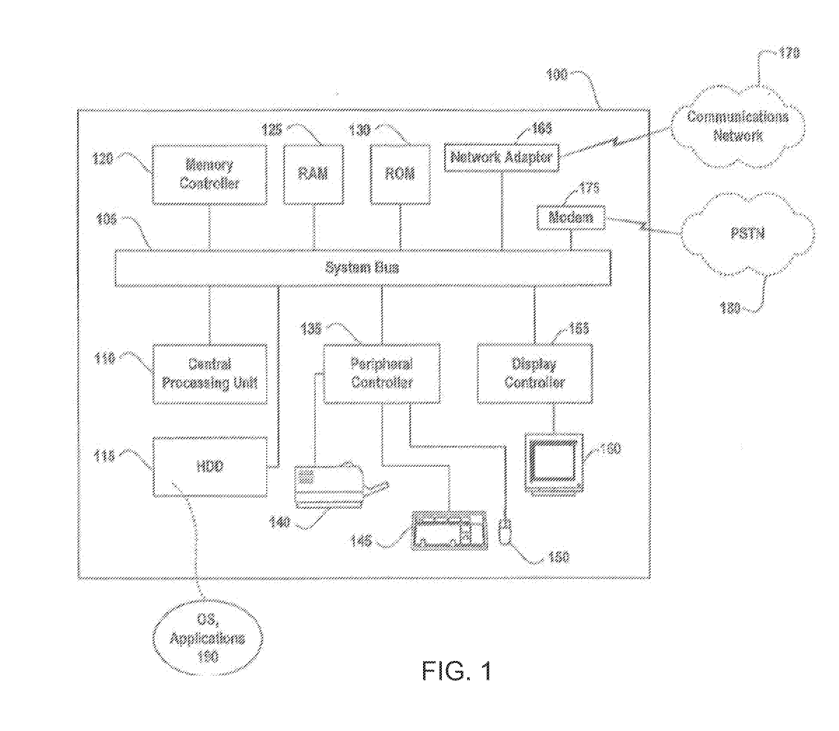

FIG. 1 depicts an exemplary computing system 100 that may be used in accordance with herein described apparatus, system and methods. Computing system 100 is capable of executing software, such as by providing an operating system (OS) and a variety of executable computing applications, or “apps,” 190. The operation of exemplary computing system 100 is controlled primarily by computer readable instructions, such as instructions stored in a computer readable storage medium, such as hard disk drive (HDD) 115, optical disk (not shown) such as a CD or DVD, solid state drive (not shown) such as a USB “thumb drive,” or the like. Such instructions may be executed within central processing unit (CPU) 110 to cause computing system 100 to perform operations. In many known computer servers, workstations, personal computers, mobile devices, and the like, CPU 110 is implemented in an integrated circuit called a processor.

It is appreciated that, although exemplary computing system 100 is shown to comprise a single CPU 110, such description is merely illustrative as computing system 100 may comprise a plurality of CPUs 110. Additionally, computing system 100 may exploit the resources of remote CPUs (not shown), for example, through communications network 170 or some other data communications means.

In operation, CPU 110 fetches, decodes, and executes instructions from a computer readable storage medium such as HDD 115. Such instructions can be included in software such as an operating system (OS), executable programs, apps, and the like. Information, such as computer instructions and other computer readable data, is transferred between components of computing system 100 via the system's main data-transfer path. The main data-transfer path may use system bus architecture 105, although other computer architectures (not shown) can be used, such as architectures using serializers and deserializers and crossbar switches to communicate data between devices over serial communication paths. System bus 105 can include data lines for sending data, address lines for sending addresses, and control lines for sending interrupts and for operating the system bus. Some busses provide bus arbitration that regulates access to the bus by extension cards, controllers, and CPU 110. Devices that attach to the busses and arbitrate access to the bus are called bus masters. Bus master support also allows multiprocessor configurations of the busses to be created by the addition of bus master adapters containing processors and support chips.

Memory devices coupled to system bus 105 can include random access memory (RAM) 125 and read only memory (ROM) 130. Such memories include circuitry that allows information to be stored and retrieved. ROMs 130 generally contain stored data that cannot be modified. Data stored in RAM 125 can be read or changed by CPU 110 or other hardware devices. Access to RAM 125 and/or ROM 130 may be controlled by memory controller 120. Memory controller 120 may provide an address translation function that translates virtual addresses into physical addresses as instructions are executed. Memory controller 120 may also provide a memory protection function that isolates processes within the system and isolates system processes from user processes.

In addition, computing system 100 may contain peripheral controller 135 responsible for communicating instructions using a peripheral bus from CPU 110 to peripherals, such as printer 140, keyboard 145, and mouse 150. An example of a peripheral bus is the Peripheral Component Interconnect (PCI) bus.

Display 160, which is controlled by display controller 155, can be used to display visual output generated by computing system 100. Such visual output may include text, graphics, animated graphics, and/or video, for example. Display 160 may be implemented with a CRT-based video display, an LCD-based display, gas plasma-based display, touch-panel or touch display, or the like. Display controller 155 includes electronic components required to generate a video signal that is sent to display 160.

Further, computing system 100 may contain network adapter 165 which may be used to couple computing system 100 to an external communication network 170, which may include or provide access to the Internet, and hence which may provide or include tracking of and access to the data discussed herein. Communications network 170 may provide user access to computing system 100 with means of communicating and transferring software and information electronically, and may be coupled directly to computing system 100, or indirectly to computing system 100, such as via PSTN, WiFi, or cellular network 180. Additionally, communications network 170 may provide for distributed processing, which involves several computers and the sharing of workloads or cooperative efforts in performing a task. It is appreciated that the network connections shown are exemplary and other means of establishing communications links between computing system 100 and remote users may be used.

It is appreciated that exemplary computing system 100 is merely illustrative of a computing environment in which the herein described systems and methods may operate and does not limit the implementation of the herein described systems and methods in computing environments having differing components and configurations. That is to say, the inventive concepts described herein may be implemented in various computing environments using various components and configurations.

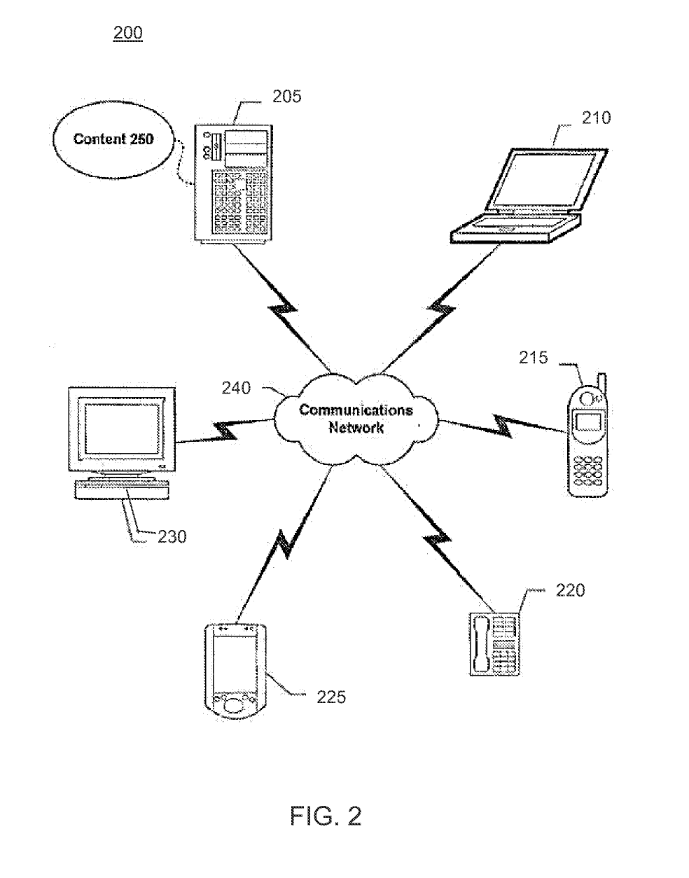

As shown in FIG. 2, computing system 100 may be deployed in networked computing environment 200. In general, the above description for computing system 100 applies to server, client, and peer computers deployed in a networked environment, for example, server 205, laptop computer 210, desktop computer 230, and various mobile computing devices 215. FIG. 2 illustrates an exemplary illustrative networked computing environment 200, with a server in communication with client computing and/or communicating devices via a communications network, in which the herein described apparatus and methods may be employed.

As shown in FIG. 2, server 205 may be interconnected via a communications network 240 (which may include any of, or any combination of, a fixed-wire or wireless LAN, WAN, intranet, extranet, peer-to-peer network, virtual private network, the Internet, or other communications network such as POTS, ISDN, VoiP, PSTN, etc.) with a number of client computing/communication devices such as laptop computer 210, wireless mobile smart device/phone 215, wired telephone 220, stand-alone GPS tracking device 225, user desktop computer 230, and/or other communication enabled devices (not shown). Server 205 can comprise dedicated servers operable to process and communicate data such as digital content 250 to and from client devices 210, 215, 220, 225, 230, etc. using any of a number of known protocols, such as hypertext transfer protocol (HTTP), file transfer protocol (FTP), simple object access protocol (SOAP), wireless application protocol (WAP), or the like. Additionally, networked computing environment 200 can utilize various data security protocols such as secured socket layer (SSL), pretty good privacy (PGP), virtual private network (VPN) security, or the like. Each client device 210, 215, 220, 225, 230, etc. can be equipped with an operating system operable to support one or more computing and/or communication applications, such as a web browser (not shown), email (not shown), or independently developed applications, the like, to interact with server 205.

The server 205 may thus deliver and/or or communicate via applications specifically designed for remote devices, such as mobile client devices, such as, for example, smart device 215. Smart device 225 may be any mobile computing device, telephone, PDA, tablet or smart phone and may have any device compatible operating system. Such operating systems may include, for example, Windows, Symbian, RIM Blackberry OS, Android, Apple iOS, Windows Phone, Palm webOS, Maemo, bada, MeeGo, Brew OS, and Linux. Although many mobile operating systems may be programmed in C++, some may be programmed in Java and .NET, for example. Some operating systems may or may not allow for the use of a proxy server and some may or may not have encryption. Of course, because many of the aforementioned operating systems are proprietary, in certain prior art embodiments server 205 delivers to smart devices 215 only those applications and that content applicable to the operating system and platform communication relevant to that client device 215, 225 type.

While smart device 215 typically relies on a cellular carrier service with monthly or per transaction data transmission fees, in order to collect and transmit, in real-time, GPS tracking data over communications network 240 to server 205, the stand-alone GPS tracking device 225 may enable simpler, cheaper communication of tracking data by storing the recorded location data within the unit for a later wired transfer of the stored data via, for example, laptop computer 210 or desktop computer 230. Alternatively location data may be transferred in real-time from the GPS device 225 to a central location data base, or internet-connected computer, using a cellular (GPRS or SMS), radio, or satellite modem embedded in the unit. The monthly or per transaction wireless service fee for stand-alone GPS unite 225 is typically less than the wireless service fees for smart device 215.

A further alternative to save cost, namely by limiting wireless service fees, is to collect GPS location data on smart device 215 facilitated by a specially designed application (app) that will not transmit the data over the communications network until smart device 215 is able to transmit over the communications network without incurring a wireless service fee or depleting from a pre-set data transmission allowance established by a wireless carrier for smart device 215.

GPS location data transmitted, in real-time or from a later connection to the network, from either smart device 215 or stand-alone GPS tracking device 225, allows a driver's location to be displayed against a map backdrop, using GPS tracking software. Data tracking software may also be utilized on smart device 215 with the aforementioned GPS capability.

The present invention is and includes a software platform (i.e., server and client as described in FIGS. 1 and 2) that allows for receiving driver and advertiser/ad campaign profiles, for matching drivers to ad campaigns, and for tracking ad campaign and/or driver performance. More particularly, the present invention may be and include the tracking of vehicles, such as using GPS, triangulation, or the like, wherein the vehicles, which may be automobiles, trucks, buses, heavy machinery, airplanes, or the like, are “wrapped” or similarly engaged with certainty with one or more advertisements. Thereby, a bread crumb trail is created of the movements of the vehicle using said tracking. For example, times, speed, and routes may be tracked, and compared with, for example, pedestrian and/or department of transportation traffic records, such as federal records, state records, region records, local records, and/or combinations thereof, or the like, such as may be available electronically and from remote domains/servers, to indicate a number of impressions of the advertisement placed upon the vehicle.

By way of non-limiting example, computing code, as discussed in detail with regard to FIGS. 1 and 2, may be employed which incorporates a state's department of transportation data, such as may include average annual daily traffic on particular routes within the state, the average number of people per vehicle that constitute the annual average daily traffic, whether or not a median is present on particular routes, the number of lanes on particular routes, the number of pedestrians on particular routes, and/or the like. Accordingly, a route, such as may be tracked using GPS or as may be entered by a driver, may carry with it a number of impressions when compared to the department of transportation data, and wherein the number of impressions may be modified based on the time of travel, speed of travel, or the like.

Thus, the entry into the computing code of GPS data, and/or prospective travel data, may indicate a number of impressions. As such, placement of the advertisement may be corresponded to the number of impressions received over a particular time period, such as in a day, a week, a month, a quarter, a year, or the like. Further, verification of the route, time of day, speed, and the like may allow for verification of the number of impressions, and hence verification of compliance with the ad campaign profile prior to payment from the advertiser. In short, a number of impressions may be quantified for an advertisement placed on a vehicle, and this number of impressions may later be validated.

Moreover, any of a variety of tracking mechanisms may be employed in addition to, in conjunction with, or in replacement of, for example, GPS data. For example, tracking data may include traffic camera verifications, Bluetooth reading, EZPass indications, smart chip reads, license plate reads, sensing of a smart phone or number of smart phones in a vehicle having the advertisement or in a vehicle proximate to the advertisement, or the like. Thus, the advertising vehicle may have its route tracked, and a number of impressions may consequently be indicated. Such alternative methodologies to gain a number of impressions may also be compared with, for example, department of transportation data, may be used in place of department of transportation data, or may be employed in a weighted manner in conjunction with department of transportation data.

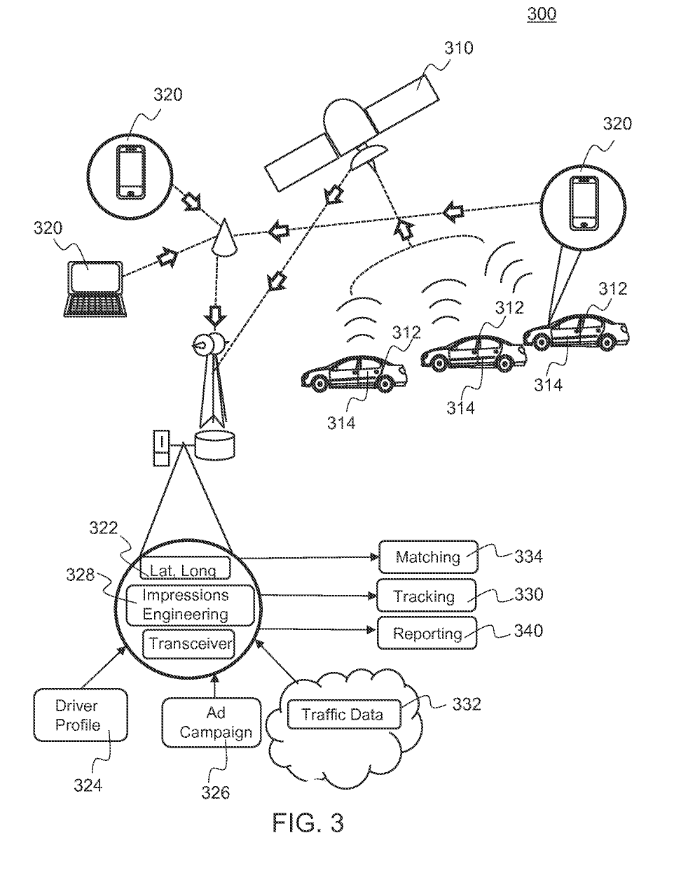

FIG. 3 illustrates a mobile advertisement tracking and impressions analytics system 300 in accordance with the present invention. As illustrated, the system 300 may include, in an exemplary embodiment, one or more GPS tracking satellites 310, a plurality of vehicles 312 each corresponded to a driver, a plurality of advertisement wraps 314, magnetic advertisements, or the like, for association with each of the particular vehicles, and a plurality of computing interfaces 320 to allow for interaction with the system by at least the operators of the plurality of vehicles, advertisers wishing to place the advertisements in correspondence with the plurality of vehicles, and system administrators, such as in order to first match 334 drivers to advertisers, and to perhaps facilitate tracking 330 and reporting 340. Further, data 322 from the aforementioned GPS satellites may be accessible to the system in addition to the aforementioned vehicle operator/driver 324 and advertiser data 326. The latitude, longitude, and variety of other data with regard to each vehicle may thereby enter into the system. Further, estimated routes may be entered by the plurality of drivers. Further, a desired number of impressions or routes, and monies to be associated with the number of impressions, may be entered by the advertiser. Impression engineering models 328 may be performed and/or accessed by the instant invention, and may apply traffic and traffic engineering data 332, such as third party data obtained over a network, to the longitude and latitude of GPS data in order to generate a number of impressions (this may also be performed according to the driver's entered route) in order to allow for comparison to the ad campaign buy. This number of impressions, as indicated by the ultimate route(s).

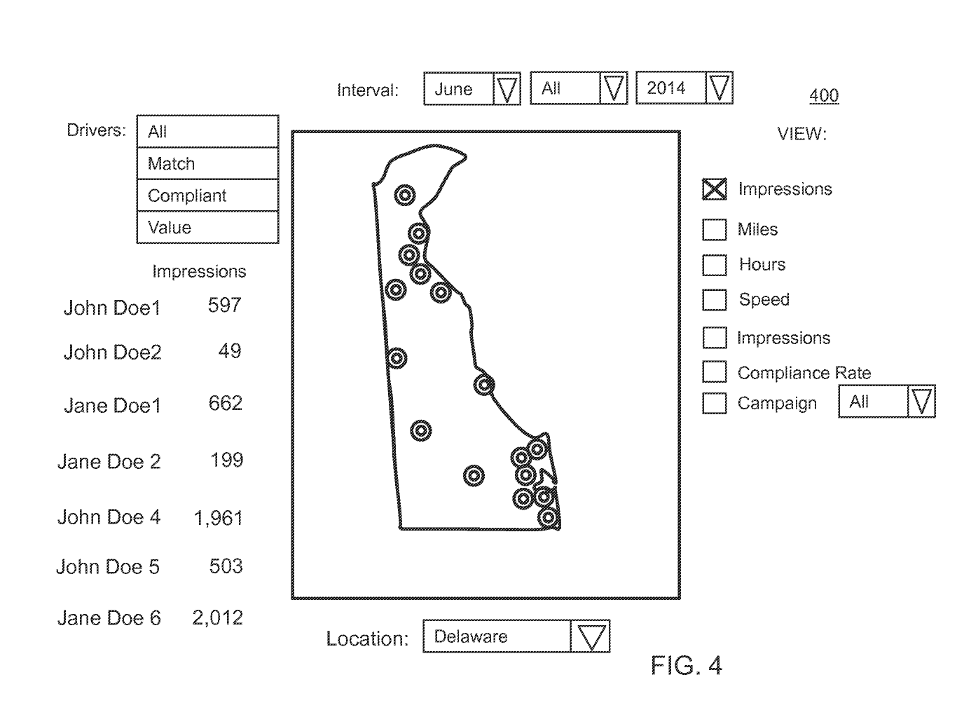

FIG. 4 is an exemplary illustration of a general dashboard 400 in accordance with the present invention. The dashboard shown may be for use by an administrative person, and/or an advertiser, associated with the present invention. As shown, the dashboard may allow for a plurality of drill downs, and may show at a top level a map having associated therewith a plurality of drivers. The plurality of drivers may be each associated with certain driver information, such as an identifier associated with the driver's smartphone device, the driver's estimated route or number of impressions, the driver's vehicle identification, or the like. Elsewhere, at the top level may be provided an ability to select drill down data in accordance with the invention, such as number of impressions upon selection of a driver, miles driven by a driver, time driven by a driver, vehicle hours during a particular timeframe for a driver, type of vehicle of a driver, demography of a driver, demography of a driver's route, or the like. The foregoing information may be enhanced by selecting a particular interval, such as a time of a particular day, a particular day, a month, a year, or the like. It goes without saying that the administrative dashboard may include similar information to that which is selectable, and may be drilled down into, on behalf of advertisers using the instant invention.

The adaptable data collection and analytics platform disclosed herein allows an advertising campaign to be matched, based on the expressed preferences of the advertiser, with the one or more driver/operators of mobile vehicles, at any desired level of matching to the ad campaign profile. That is, the expressed preferences of an advertiser may indicate a particular type of driver, a particular type of vehicle, a particular number of impressions, a particular route or routes, a particular time of travel, a particular type of demographic indicated by a particular neighborhood, a particular time of travel, a particular speed, a particular vehicle type, combinations thereof, and a weighting thereof, or the like.

The use of computing code, a display, and the computer-implemented system discussed herein may allow for the driver, the advertiser, an administrator, or combinations thereof to be provided with a visual dashboard 400. For example, an advertiser may be provided with a dashboard in order to make an advertisement buy, i.e., in order to enter and track an ad campaign. Additionally, participating vehicle operators may be provided with the same or a similar computing dashboard, i.e., in order to enter a driver profile. Likewise, administrative persons operating the present system and methodology may be provided with a computing dashboard.

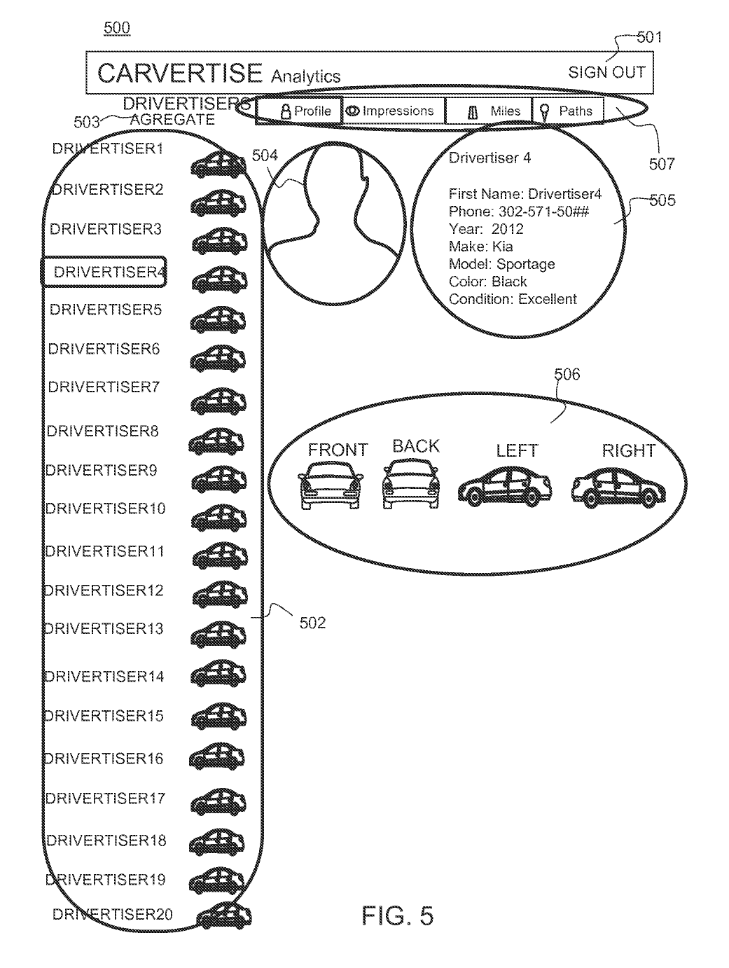

FIG. 5 illustrates a profile view 500 as one component of an embodiment of the aforementioned dashboard, wherein a profile of an operator/driver may be graphically displayed. The profile view, as with all pages of the dashboard, may include a dynamically hyperlinked, graphically selectable sign in/sign out icon/display 501 to facilitate the maintenance of secure access, by only per-authorized users, to specific categories of confidential information contained within the database. As noted above, pre-authorized users may be provided with varying levels of confidential access. For example, a driver may only be able to view her own profile, while an advertiser can view the profile of all drivers on the advertiser's current campaign, but not other drivers. System administrators may be authorized to view all confidential information.

Profile view 500 may further include a list of drivers 502 which, like the sign in/sign out icon, may be individually, dynamically selectable. Individually, dynamically selectable means each driver in the listed is hyperlinked and selecting the hyperlink will pull up specific data concerning the selected driver, which will vary depending on the view. For example, while in the profile view, selecting driver #4 from the list will pull up the profile information for driver #4, and may change the appearance of driver #4 in the list in comparison to the rest of the list to make clear which driver profile is being displayed. Driver list 502 may be a feature that remains viewable at the same location from multiple different views/pages within dashboard 400. Within or near driver list 502 may be an aggregate selection 503, which may always be viewable/selectable wherever the driver list 502 is displayed. Aggregate selection 503 allows for data regarding all drivers, in aggregate, to be displayed in the current view/page. Profile view 500 may further include a profile picture 504 of the driver, driver profile information 505, such as name, phone number, email address, year of driver's vehicle, as well as vehicle make, model, color and condition. The profile view 500 may also include photographic pictures of the driver's vehicle 506, including front, back, left, and right views of the vehicle. Finally, profile view 500 may include a dynamically selectable toolbar 507 that includes an icon for each view/page that may be selected and viewed for each driver, or the aggregate of all drivers, within the dashboard. In addition to profile view 500, these views may include an impressions view 600, a miles view 700, and a paths view 800.

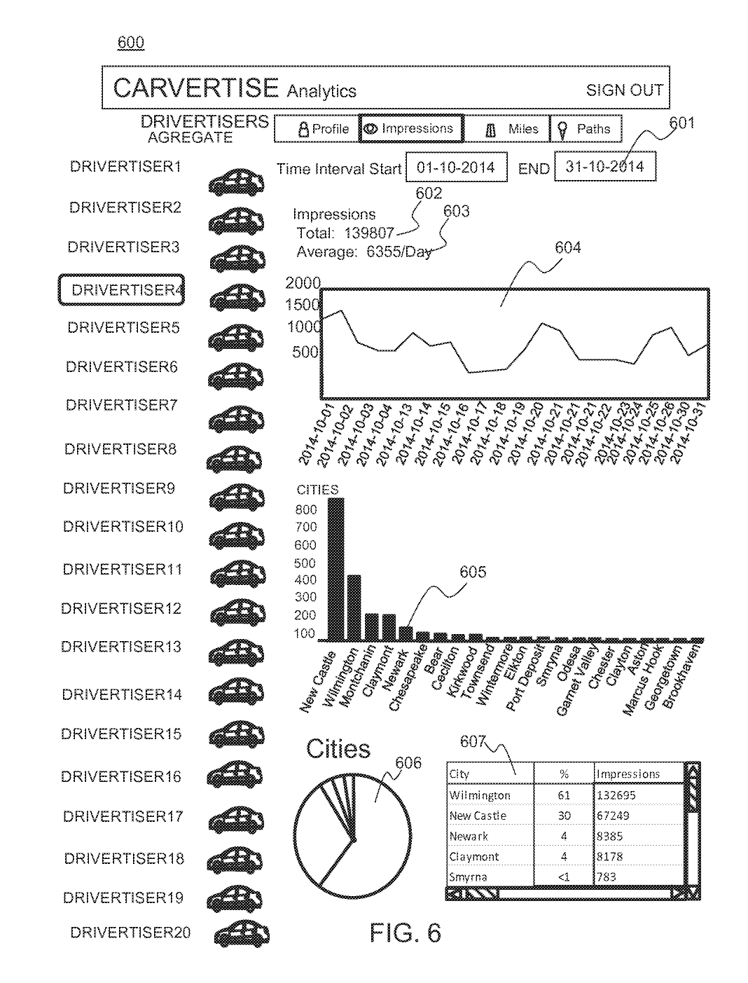

FIG. 6 illustrates impressions view 600 as another component of one possible embodiment of the dashboard, wherein the calculated number of impressions determined for a particular driver, or the aggregate of all drivers, over a selected period of time may be graphically displayed. Impressions view 600 may include the aforementioned sign in/sign out icon 501, drivers list 502 and aggregate 503 selections, and all views toolbar 507, appearing at the same locations as displayed on profile view 500. Impressions view 600 may further include an interface through which a user may select or enter a time interview 601, either by selecting start and end dates through a popup calendar date selection feature or by typing into start and end date entry fields. Entering dates in time interval 601 allows for the system to calculate the number impressions made by each driver over that interval. The driver's total number of impressions may be numerically displayed 602 on impressions view 600, along with an average number of impressions per day by the driver 603. Total impression may also be graphically displayed, for example, by a line or area chart 604. The graphical displays may also include break downs of the calculated impressions by cities and towns or other readily identifiable geographic locations. For example impressions view 600 may include a bar chart 605 comparing impressions by city/geographic location or by a pie chart 606 to illustrate impressions by city as a percentage of the total number of impressions. The display may further include a small sub-window that contains a navigable/scrollable and hyperlinked table or spreadsheet 607 showing the number of impressions per city and the percentage this constitutes of the total number of calculated impressions for the selected driver over the selected time interval. Hyperlinking the table spreadsheet chart may take the user to a new spreadsheet view/page within the system where the user may be able to view, navigate and recalculate the categories of data described herein in the form of a spreadsheet.

Impressions view 600 allows for the calculation and graphical display of impression over a selected time interval not only for each individual driver but also for all drivers in aggregate. The ability to calculate and display the data in aggregate also applies to the miles and paths views further described below. The system may be preconfigured so that the aggregate feature is unique to a specific authorization or purpose. For example, a specific advertiser may only have the authorization and purpose to view drivers within their advertising campaign or a manager may only wish to view cars within a specific preset region. These parameters may be preset so that the advertiser only sees her campaign's cars or a manager may select an aggregate for a specific region.

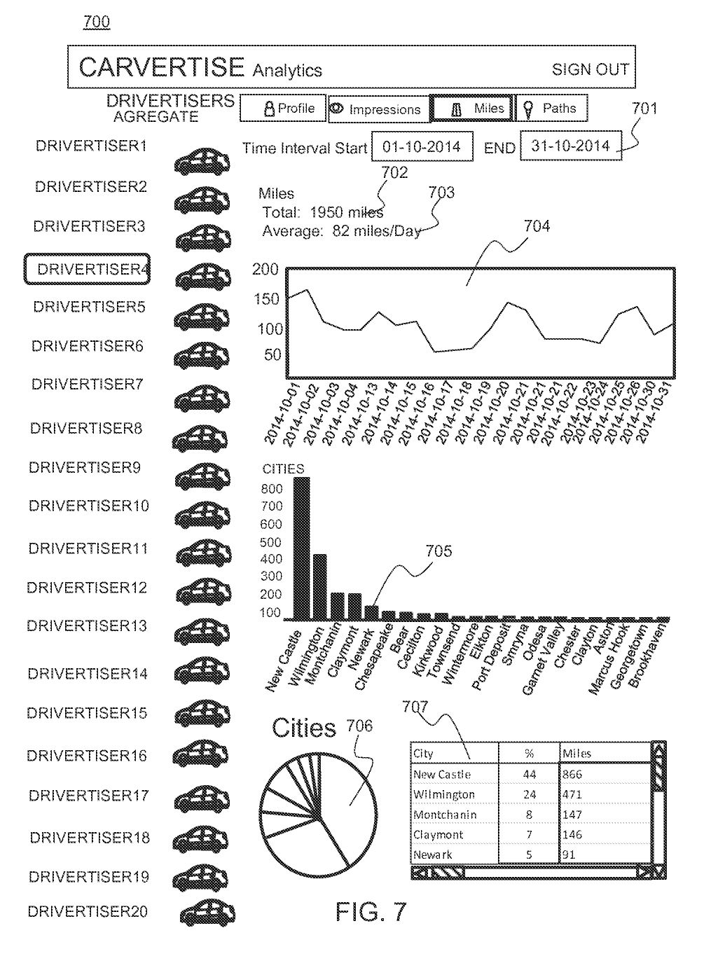

FIG. 7 illustrates miles view 700 as another component of one possible embodiment of the dashboard, wherein the calculated number of miles determined for a particular driver, or the aggregate of all drivers, over a selected period of time may be graphically displayed. Miles view 700 may include the aforementioned sign in/sign out icon 501, drivers list 502 and aggregate 503 selections, all views toolbar 507, and time interval date entry interface 701, appearing at the same locations as displayed on profile view 500 and impressions view 600. Similar to impressions view 600, entering dates in the time interval interface 701 allows for the system to calculate the number of miles made by each driver over that interval. Further similar to the impressions view, miles driven by each driver may be numerically displayed as total miles 702, and/or average daily 703. Total miles may also be graphically displayed, for example, by a line or area chart 704. The graphical displays may also include break downs of the calculated miles by city/geographic location. As with impressions view 600, miles view may include a bar chart 705 comparing miles by city/geographic location or by a pie chart 706 to illustrate miles by city as a percentage of the total number of miles driven by the driver over the selected interval. The display may further include a small sub-window that contains a navigable/scrollable and hyperlinked table or spreadsheet 707 showing the number of miles per city and the percentage this constitutes of the total number of calculated miles for the selected driver over the selected time interval. As with this table in impressions view 600, hyperlinking table/spreadsheet 707 may allow the user to navigate to new spreadsheet view of the database.

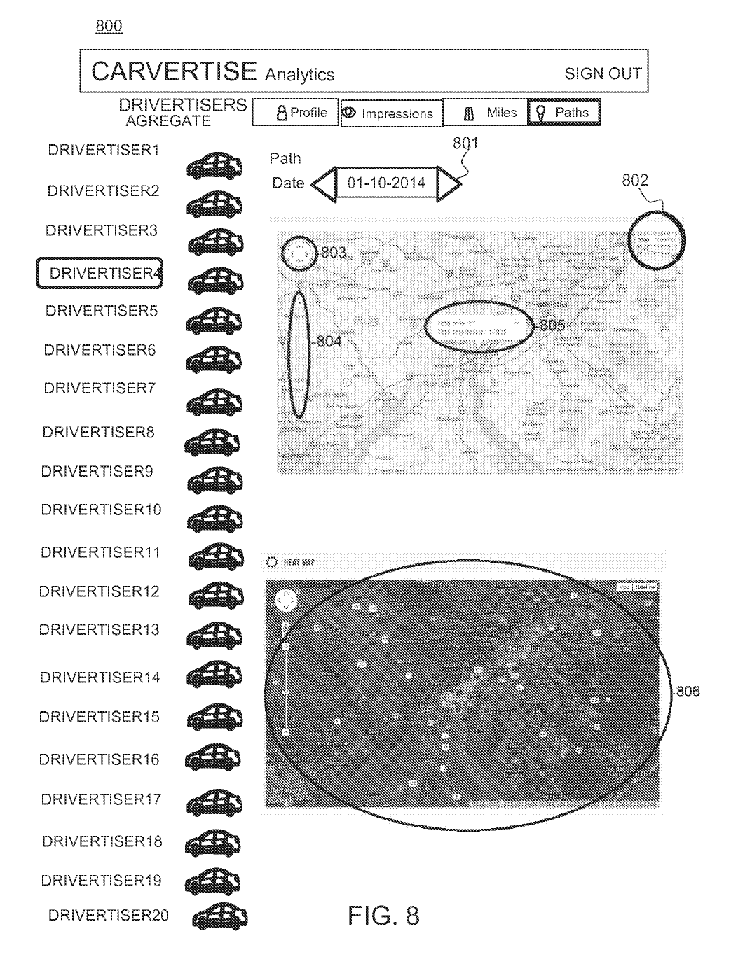

FIG. 8 illustrates paths view 800 as another component of one possible embodiment of the dashboard, wherein the determined path of a particular driver, or the aggregate of all drivers, over a selected period of time may be graphically displayed. Paths view 800 may include the aforementioned sign in/sign out icon 501, drivers list 502 and aggregate 503 selections, all views toolbar 507, and date entry interface 801, appearing at the same locations as displayed on profile view 500, impressions view 600, and miles view 700. Paths view 800 may include one or more maps to illustrate the driven routes of one or more drivers. Maps view 800 may include a map with multiple adjustment options including, icons to switch between map and satellite views 802, an icon to directionally move 803 the displayed regions, an icon to enlarge or reduce 804 the viewing area of the map, and a popup/dialogue box 805 to display numerical data associated with, and point to, one or more paths currently displayed on the map. The numerical display may include, for example, total miles and/or total impressions for the selected path. Maps view 800 may further include a heat map 806. Heat map 806 may display the intensity of a drivers' travels within regions of the viewable area on the map similar to, for example, the intensity displayed on a weather radar map displaying storm activity or temperature gradients/zones. As with impression view 600 and miles view 700, the data displayed on paths view 800 may be a selected individual driver or may be for an aggregate of drivers for the selected date or time interview.

As detailed above, the computing dashboard may provide detailed analytics in accordance with calculations, comparisons, algorithms, and indications. As noted, the dashboard may expose to one or more authorized users a number of impressions per driver, or aggregate of drivers. The dashboard may allow data to be viewed across one or more specific advertising campaigns. It may further provide an availability to choose a desired number of impressions, or a location for some or all impressions. The dashboard may allow a user to enter a route or a demography that is then corresponded to a number of impressions.

The system may further allow the automated matching of advertisers to vehicle operators based on parameters selected by an advertiser or other authorized user of the dashboard including, for example, number of desired impressions in a particular geographic area using particular vehicle types with certain driver demographics. The match results may be displayed through the dashboard, with a binding contract electronically selectable by the advertiser receiving the automated match results.

As noted above, the one or more dashboards provided by the present computing code may provide alternative views and data entry availability dependent upon the party then logged into the dashboard. For example, a vehicle operator may log in to provide a travel plan, such as a daily travel plan, a weekday travel plan, a weekend travel plan, or the like. The analytics of the present invention, such as by incorporating department of transportation data, may engage in, for example, a calculation, simulation, or the like, to indicate a number of impressions that are likely based upon the entered travel plan. This number of impressions, and various additional factors, such as time of day, may then be compared with ad campaign data entered by at least one advertiser into an advertiser's dashboard, in order to match the vehicle operator with one or more advertisers. Of course, an advertiser's dashboard may additionally provide various other detailed information to allow for more specific requests, such as routes having low speed limits and high pedestrian traffic, by way of non-limiting example.

Additionally, based on the aforementioned variety of tracking methodologies to track compliance with driver routes, and more particularly vehicles corresponded with driver routes, the number of impressions may be at least approximately verified with regard to an ad campaign previously entered into the advertiser's dashboard. Needless to say, this information may then be returned to the advertiser in the advertiser's dashboard for viewing and verification by the advertiser, or may be otherwise reported to the advertiser.

In accordance with the foregoing, the instant invention provides nearly unlimited scalability, at least in that a number of impressions may be initially estimated in order to allow for an ad campaign advertising buy, and may thereafter be verified using one or more verification methods, such as incorporation of data from and comparison to traffic engineering models from a department of transportation. Thereby, a number of impressions of the advertisements placed on the mobile vehicle may provide a charging model for the placement of the advertisements on the vehicle. Consequently, drive time or simple driver estimations are no longer necessary to serve as the sole or most significant basis for a charging model with regard to a moving vehicle advertisement. As such, the advertising model for a moving vehicle that is discussed herein well-approximates an internet based, per impressions advertising model, and need not be based on speculative approximation or trust in a driver.

It has been estimated that nearly 60% of the present population between the ages of 18 and 55 has a smart device/phone 215. Moreover, it has been estimated that over 80% of persons between the ages of 18 and 35 has a smart phone. Accordingly, the present invention may readily be provided as a mobile app, such as to drivers, advertisers, administrators, and the like. Thus, for example, it may be readily known by the present system, and/or by an administrator of the present system, what the value of a particular driver may be upon that driver's interaction with the app. More particularly, GPS data, and demographic information of the GPS data, may be available via the driver's smart device 215, and may accordingly be used to a assign a particular number of impressions to which that driver will likely be exposed in the future in a given time frame, such as daily, monthly, annually, or the like. Needless to say, this would allow an advertiser interacting with the advertiser's version of the app to select, preferably anonymously, a driver or drivers representing the routes, demography, or the like that is preferred by the advertiser.

Consequently, and in light of the foregoing, the present invention provides a GPS or other tracking methodology to impression conversion. Of course, the GPS tracking unit may be provided to a driver upon executing an ad campaign, or the driver's mobile device GPS may be employed, by way of non-limiting example. Through this use of geo-location tracking, the instant invention provides an outdoor “online advertising” model, whereby an outdoor eyeball measurement maybe provided that varies based on the outdoor route of a vehicle.

More particularly, and with regard to an advertiser's dashboard, the aforementioned bread crumb trail for a plurality of drivers may be available, such as in a drill down feature whereby a top level plurality of drivers may be selected. The selectable drivers may be provided, and/or later tracked, in accordance with an advertiser's indicated criteria, such as number of impressions, zip code traveled, demographic area traveled, neighborhood, number of pedestrians along route, or the like.

Further, an administrative log in may be provided to allow administrators of the instant invention to track available drivers, compliance with driver indicated routes, times, number of impressions, or the like, and to manage the overall operation of the present methodology. For example, a vehicle operator has data correspondent thereto, including GPS data, estimated route data, number of impressions, and the like. An advertiser may have corresponded thereto a number of desired impressions, a particular advertising campaign which may have a variety of features each corresponded to a number of eyeballs, a particular route, or the like. The advertiser may further have associated therewith an indicated advertising buy in which money is equated to a number of impressions. Thus, an administrator of the instant invention may manually manage, for example, an aggregation of drivers on a particular route, wherein the multiple drivers are used to meet the ad campaign buy, rather than the advertiser selecting an individual or several individual drivers. Preferably, this matching and/or execution may be performed automatically by the computing code. Verification of the aggregation indicated by the administrator as to the correct number of eyeballs and meeting of the advertiser's other preferences may then be made available to the advertiser, such as via the previously discussed advertiser's dashboard.

While embodiments of this invention have been shown and described, it will be apparent to those skilled in the art that many more modifications are possible without departing from the inventive concepts herein. The invention, therefore, is not to be restricted to the disclosed embodiments.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but rather is to be accorded the widest scope consistent with the principles and novel features disclosed herein.

That which is claimed:

1. A method for collecting and utilizing geo-location data over a network to verify driver reported route information for non-commercial automobiles, comprising:
(a) electronically receiving at one or more servers, through a secure web-interface, one or more data files containing reported data submitted by owners of non-commercial automobiles, the one or more data files including owner reported time and location data regarding the routine driving route of an automobile, and said one or more data files not including time and location data captured from a tracking device located within said automobile;
(b) after step (a), for each reported automobile, prompting a tracking device activated within the automobile to automatically capture route tracking information, including time and location data, associated with the route of the automobile, and to transmit said route tracking information to the one or more servers;
(c) after step (b), receiving at the one or more servers said tracked route information for each automobile, and associating said tracked route information with reported data for the same automobile; and
(d) comparing, by a rules-based decision engine located at the one or more servers, said reported data for each vehicle with said tracked route information for the same vehicle, to determine whether the reported data matches the tracked route information, within a range of tolerances pre-established for the rules-based decision engine.

2. A cloud-based software analytics platform with limited secure portal access for customers and agents to access selective GPS-related information to which those customers and agents are authorized wherein:
(a) the platform further includes a rules-based decision engine enabled to automatically find and match drivers of privately owned vehicles with advertisers intending to launch a mobile advertising campaign on privately owned vehicles, and
(b) wherein the platform is further enabled to provide real-time data access, including the estimated number of impressions based on data regarding traffic, population density, driven miles, driven routes and consumer feedback related to the advertising campaign driven by the private drivers.

3. A method of gathering data to ascertain impressions made by a mobile advertisement by utilizing the detection through a mobile device of third-party wireless signals, such as smartphone bluetooth, wifi networks, and hotspots, the method including:
(a) collecting information regarding the location, time, strength, type, and duration of third-party wireless signals detected in association with the mobile advertisement by a driver's smartphone, when the smartphone is traveling with and near a mobile advertisement; wherein the information is collected in order to aid in the assessment of the demographic environment in which the mobile advertisement is traversing; wherein the third-party wireless signals, networks, and hotspots are those other than ones established by, through or on behalf of the mobile advertiser and its agents;
(b) determining from the collected information an estimated number of consumer impressions made by the mobile advertisement;
(c) determining an estimated average age and income range of the consumers making up the impressions calculation.

4. A cloud-based software analytics platform for gathering information along and about the route of a dynamic mobile advertisement, with variable content options, driven by a driver's personal vehicle, wherein:
a personal mobile device of the driver automatically gathers and communicates, in real-time, location tracking information associated with the mobile advertisement;
a server receives the location tracking information from the personal mobile device and decides, through a rules-based decision engine, when to change the content of the dynamic mobile advertisement based on additional data received related to the location of the mobile advertisement;
a consumer feedback module wherein real-time consumer feedback is received, either from social media or from sound and light sensors connected to the personal mobile device, and transmitted to the server for further automated decisioning regarding when to change the content of the dynamic mobile advertisement based on the consumer feedback;
a third-party wireless signals module wherein real-time environmental data is gathered regarding the density and type of third-party wireless signals, and said environmental data is transmitted to the server for further automated decisioning regarding when to change the content of the dynamic mobile advertisement based on the environmental data;

5. A personal vehicle tracking system including one or more servers and a GPS-enabled mobile device associated with each personal vehicle to be tracked, wherein:
the mobile device contains an app that collects and communicates via a communications network, to the one or more servers, GPS tracking data obtained through the mobile device; and
wherein the one or more servers automatically processes, with a rules-based decision engine, the tracking data to determine whether repeated routes driven by the personal vehicle meet criteria selected for a particular mobile advertisement campaign.

6. A coupled, mobile wireless signal and visual advertisement transmission system including:
a vehicle to transport (i) a near-range wireless signal transmitter that transmits advertising content through the wireless signal (ii) a mobile visual advertisement; wherein
the mobile visual advertisement informs the nearby consumer public how to receive the transmitted wireless signal to obtain the advertisement content.

7. The transmission system of claim 6, wherein the near-range wireless signal transmitter transmits FM radio signals.

8. The transmission system of claim 6, wherein the near-range wireless signal transmitter transmits AM radio signals.

9. The transmission system of claim 6, wherein the near-range wireless signal transmitter transmits wifi signals.

10. The transmission system of claim 6, wherein the near-range wireless signal transmitter transmits bluetooth signals.

11. A mobile feedback collections device, including:
a mobile advertisement connected to a vehicle where the advertisement solicits a non-oral feedback communication from one or more drivers of nearby vehicles, wherein the communication includes one or more of the following; (i) flashing automobile headlight high-beams; (ii) turning an automobile's headlights off; (iii) turning an automobile's headlights off; (iv) sounding an automobile horn;
a mobile device with light and sound sensing capability in order to discern, capture, and relay the feedback communication received from the one or more nearby drivers;
wherein the mobile device is further configured to log the time and location at which the feedback communication was received, and to transmit, in real-time, the logged information to a centralized server that may further record and process the information.
